(19) United States
(12) Patent Application Publication
(10) Pub. No.: US 2007/0239801 A1
(43) Pub. Date: Oct. 11, 2007

(54) INFORMATION RECORDING MEDIUM, AND REPRODUCING MEDIUM AND APPARATUS

(75) Inventors: Tae-hee LEE, Yongin-si (KR); Jung-wan Ko, Suwon-si (KR); Jung-suk Kang, Suwon-si (KR); Pan-gie Park, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/689,215

(22) Filed: Mar. 21, 2007

Related U.S. Application Data
(60) Provisional application No. 60/789,884, filed on Apr. 7, 2006.

(30) Foreign Application Priority Data
Apr. 7, 2006 (KR) 2006-32099

(51) Int. Cl. G06F 17/30

(52) U.S. Cl. 707/203

(57) ABSTRACT

An information recording medium and a reproducing method and apparatus are provided, so as to effectively update software in the reproducing apparatus. The information recording medium is provided with data and information for updating software stored in an apparatus which reproduces data from the information recording medium.

### CROSS-REFERENCE TO RELATED APPLICATIONS

This application claims all benefits accruing under 35 U.S.C. §119 from Korean Patent Application No. 2006-32099, filed on Apr. 7, 2006 in the Korean Industrial Property Office and U.S. Provisional Patent Application No. 60/789,884, filed on Apr. 7, 2006, in the U.S. Patent and Trademark Office, the disclosures of which are incorporated herein by reference.

### BACKGROUND OF THE INVENTION

1. Field of the Invention

The present invention relates to an information recording medium and a reproducing method and apparatus which are capable of updating software of an apparatus that can reproduce data stored on the information recording medium.

2. Description of the Related Art

Electronic devices and systems use removable information storage media for a variety of purposes, from reproducing music, playing movies, archiving data, to sharing files between computers. The type of media used for removable information storage has changed over time, transitioning from magnetic or other types of media to optical media, such as compact discs (CDs) or Digital Versatile Discs (DVDs). Examples of next generation optical appliances are hybrid High Density Digital Versatile Discs (HD DVD) and hybrid Blu-Ray Discs (BD). Hybrid HD DVD reproducing apparatus and hybrid BD reproducing apparatus support the reproduction of data from both a DVD and a CD, which are conventional recording media. However, time is needed by a manufacturer to stabilize the quality, configuration, and features of a product that can support next generation optical media and especially of a product that can support both conventional recording media and new types of media. While an apparatus can reproduce data from media sold during development of the reproducing apparatus, the software installed on the previously sold reproducing apparatus may need to be updated in order to reproduce data stored on media sold after the developed reproducing apparatus was initially placed on the market. Additionally, updated software may be released that improves the performance, reliability, adds additional features, or corrects a design defect of the apparatus.

When software in a reproducing apparatus sold to a consumer needs to be updated, updating is conventionally performed, via an additional interface built into the reproducing apparatus, or by using a manufacturer or vendor supplied information recording medium (such as a CD-ROM or similar format) that is created specifically for software updating.

However, when reproducing apparatuses are sold and require an update, an effective method of informing all customers who have purchased the apparatus of updating software in all of the reproducing apparatuses has yet to be developed. As a result, a considerable time is spent and high costs are incurred in retrieving the reproducing apparatuses and updating the software. Additionally, a consumer may become upset if an information recording medium (such as a newly released movie) is purchased and his/her reproducing apparatus is unable to correctly reproduce data on the information recording medium because of a required update of which the consumer was unaware.

### SUMMARY OF THE INVENTION

The present invention provides an information recording medium, a reproducing method, and apparatus capable of updating software in an information recording medium reproducing apparatus.

Additional aspects and/or advantages of the invention will be set forth in part in the description which follows and, in part, will be obvious from the description, or may be learned by practice of the invention.

In accordance with an example embodiment of the present invention, there is provided an information recording medium for use in an apparatus which reproduces data. Such an information recording medium comprises data, and information for updating software stored in the apparatus which reproduces the data.

According to an aspect of the present invention, the information for software updating may be stored in a location of the information recording medium not accessible to the user through normal operation of the apparatus.

According to an aspect of the present invention, information for updating software may comprise a software update information file containing information regarding an update software file.

According to an aspect of the present invention, the software update information file may comprise at least one of software type information indicating which central processing unit (CPU) is capable of executing the updated software, a name of a manufacturer of the apparatus the updated software is for, a model name of the apparatus the updated software is for, information regarding the version of the updated software, and an update message to inform a user of the updated software and information about the update.

According to an aspect of the present invention, the update message may comprise at least one of a release date of the updated software file, a problem which is likely to occur unless the software is updated, a method of updating the software, a query as to whether the user desires to access a current network in order to update the software, and a query as to whether the user desires to reproduce the data by using the installed software in the apparatus without updating the software.

According to an aspect of the present invention, information for software updating may comprise a software update information file containing information regarding the update software file.

According to an aspect of the present invention, the software update information file may comprise at least one of software type information indicating which CPU is capable of executing the software update, a name of a manufacturer of the apparatus the updated software is for, a model name of the apparatus the updated software is for, information regarding the version of the software update, a name of the update software file, an update message to inform a user of the updated software and information about the update, and the update software file.

According to an aspect of the present invention, the update message may further comprise at least one of a release date of the updated software file, a problem which is likely to occur unless the software is updated, and a method of updating the software.

In accordance with an example embodiment of the present invention, there is provided an information recording medium for use in an apparatus which records data on the information recording medium, the information recording medium including a data area to record data, and a designated area to record information for updating software stored in the apparatus which records the data in the data area of the information recording medium.

According to an aspect of the present invention, the designated area on the information recording medium is not accessible to the user through normal operation of the apparatus.

According to an aspect of the present invention, the information for updating software includes a software update information file containing information regarding updated software, the software update information file includes at least one of software type information indicating which central processing unit (CPU) is capable of executing the updated software, a name of a manufacturer of the apparatus the updated software is for, a model name of the apparatus the updated software is for, information regarding the version of the updated software, and an update message to inform a user of the updated software and information about the update.

According to an aspect of the present invention, the update message further includes at least one of a release date of the updated software file, a problem which is likely to occur unless the software is updated, a method of updating the software, a query of the user as to whether the user desires to access a current network in order to update the software, and a query of the user as to whether the user desires to record the data by using the installed software in the apparatus without updating the software.

According to an aspect of the present invention, the information for software updating includes a software update information file containing information regarding the update software file, the software information file includes at least one of software type information indicating which CPU is capable of executing the software update, a name of a manufacturer of the apparatus the software update is for, a model name of the apparatus the software update is for, information regarding the version of the software update, a name of the update software file, and an update message to inform a user of the updated software and information about the update; and the update software file.

According to an aspect of the present invention, the update message further includes at least one of a release date of the updated software file, a problem which is likely to occur unless the software is updated, and a method of updating the software.

In accordance with another exemplary embodiment of the present invention, there is provided a method of reproducing data from an information recording medium. Such a method comprises reading information for updating software in an apparatus which reproduces the data, from the information recording medium; determining whether updating of the software is necessary, based on the information for software updating; and outputting an update message to the user when updating of the software is necessary.

According to an aspect of the present invention, the software may comprise at least one of software for execution by a central processing unit (CPU) of the apparatus, software for execution by an encoder or a decoder of the apparatus, and software for execution by a central processing unit of a loading device which loads the information recording medium into the apparatus.

According to an aspect of the present invention, information for software updating may comprise at least one of software type information indicating which CPU is capable of executing the updated software, a name of a manufacturer of the apparatus the updated software is intended for, a model name of the apparatus the updated software is intended for, information regarding the version of the updated software, and an update message to inform a user of the updated software and information about the update.

According to an aspect of the present invention, determining of whether updating of the software is necessary may comprise determining whether updating of the software is necessary by using the information regarding the version of the updated software.

According to an aspect of the present invention, the update message may comprise at least one of a release date of the updated software file, a method of updating the software, and a problem which is likely to occur unless the software is updated.

According to an aspect of the present invention, the update message may comprise a query as to whether the user desires to access a current network so as to update the software, and the method may further comprise accessing the network and updating the software, when the user desires to access the current network to update the software.

According to an aspect of the present invention, the update message may further comprise a query as to whether the data is to be reproduced without updating the software, and the method may further comprise reproducing the data, when an instruction to reproduce the data without updating the software is received from the user.

According to an aspect of the present invention, outputting of the update message may comprise providing, via a user interface, one of the update message contained in the information for software updating, which is read from the information recording medium, and a default update message set in the apparatus.

According to an aspect of the present invention, the method may further comprise reproducing the data from the information recording medium, when updating of the software is not necessary.

In accordance with yet another example embodiment of the present invention, there is provided an apparatus for reproducing data from an information recording medium. Such an apparatus comprises a central processing unit (CPU) arranged to control the apparatus to reproduce the data from the information recording medium; and a memory to store software to be executed by the CPU, wherein the CPU reads information for updating software in the apparatus from the information recording medium, determines whether updating of the software is necessary based on the information for software updating, and controls an update message to be output when updating of the software is necessary.

According to an aspect of the present invention, the software in the apparatus includes at least one of software for execution by the CPU of the apparatus, software for execution by an encoder or a decoder of the apparatus, and software for execution by a CPU of a loading device which loads the information recording medium into the apparatus.

According to an aspect of the present invention, the information for software updating comprises at least one of software type information indicating which CPU is capable of executing the software, a name of a manufacturer of the apparatus, a model name of the apparatus, information regarding the version of the software, and an update message informing a user of update information.

According to an aspect of the present invention, the CPU determines whether updating of the software is necessary, based on the information of the version of the software.

According to an aspect of the present invention, the update message comprises at least one of a release date of the update software file, a method of updating the software, and a problem which is likely to occur unless the software is updated.

According to an aspect of the present invention, the update message may further comprise a query of the user as to whether a user desires to access a current network and update the software, and access the network and update the software when an instruction from the user to access the network so as to update the software is received.

According to an aspect of the present invention, the update message may further comprise a query of the user as to whether the user desires to reproduce the audio/video data by using the software without updating the software, and the CPU reproduces the data, when an instruction to reproduce the data by using the software without updating the software is received from the user.

According to an aspect of the present invention, the CPU provides, via a user interface, one of the update message contained in the information for software updating, which is read from the information recording medium, and a default update message set in the apparatus.

According to an aspect of the present invention, the CPU reproduces the data from the information recording medium when updating of the software is not necessary.

In accordance with yet another example embodiment of the present invention, there is provided a method of reproducing data from an information recording medium. Such a method comprises reading information for updating software in an apparatus which reproduces the data from the information recording medium; determining whether updating of the software is necessary, based on the information for software updating; updating the software by using an update file contained in the information for software updating, when updating of the software is needed; and reproducing the data from the information recording medium.

According to an aspect of the present invention, the software may comprise at least one of software for execution by a central processing unit (CPU) of the apparatus, software for execution by an encoder or a decoder of the apparatus, and software for execution by a central processing unit (CPU) of a loading device which loads the information recording medium into the apparatus.

In accordance with another example embodiment of the present invention, an apparatus for reproducing data from an information recording medium comprises a central processing unit (CPU) to control the apparatus to reproduce the data from the information recording medium; and a memory to store software to be executed by the CPU, wherein the CPU reads information for updating software in the apparatus from the information recording medium, determines whether updating of the software is necessary based on the information for software updating, updates the software by using an update file contained in the information for software updating, and controls the data to be reproduced. According to an aspect of the present invention, the software comprises at least one of software for execution by the CPU of the apparatus, software for execution by an encoder or a decoder of the apparatus, and software for execution by a CPU of a loading device which loads the information recording medium into the apparatus.

According to an aspect of the preset invention, the information for software updating comprises at least one of software type information indicating which CPU is capable of executing the updated software; a name of a manufacturer of the apparatus the software update is for, a model name of the apparatus the software update is for, information regarding the version of the software, and a name of an updated software file.

According to an aspect of the preset invention, the CPU determines whether updating of the software is necessary based on the information regarding the version of the software.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the present invention is not limited thereto. The spirit and scope of the present invention are limited only by the terms of the appended claims. The following represents brief descriptions of the drawings, wherein:

FIG. 1 is a diagram illustrating an information recording medium according to an example embodiment of the present invention;

FIG. 2 is a schematic block diagram of an audio/video (A/V) data reproducing apparatus according to an example embodiment of the present invention;

FIG. 3 is a flowchart illustrating a method of reproducing data, according to an example embodiment of the present invention;

FIG. 4 is a block diagram of a file system of data stored in an information recording medium, according to an example embodiment of the present invention;

FIG. 5 is a diagram illustrating the construction of a software update information file shown in FIG. 4, according to an example embodiment of the present invention;

FIG. 6 is a flowchart illustrating a method of reproducing data, according to another example embodiment of the present invention;

FIG. 7 is a reference diagram illustrating a method of determining whether an update is needed, according to an example embodiment of the present invention;

FIG. 8 illustrates an update message, according to an example embodiment of the present invention;

FIG. 9 is a block diagram of a file system of data stored in an information recording medium, according to another example embodiment of the present invention;

FIG. 10 is a diagram illustrating the contents of the software update information file shown in FIG. 9, according to an example embodiment of the present invention; and

FIG. 11 is a flowchart illustrating a method of reproducing data, according to another example embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

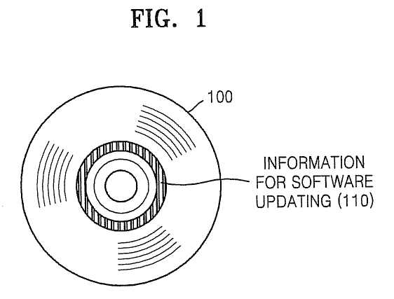

FIG. 1 is a diagram illustrating an information recording medium 100 according to an example embodiment of the present invention. Such an information recording medium 100 can include a Blu-Ray Disc (BD), High Density Digital Versatile Disc (HD DVD), hybrid BD or HD DVD, or similar format. As shown in FIG. 1, the information recording medium 100 stores recorded data, such as audio/video (A/V) data or computer files, to be reproduced by a reproducing apparatus (not shown), such as a standalone BD player. The information recording medium 100 may contain additional types of data, such as navigation data for controlling A/V data. Alternatively, rather than storing data, the information recording medium 100 can be “blank” and capable of having data written to thereon by a consumer using a reading/writing apparatus (not shown). In an example embodiment of the present invention, the information recording medium 100 additionally contains information for software updating 110. By storing in the information recording medium 100 the information for software updating 110, it is possible to rapidly and effectively provide a user with a software update or information about a software update, and easily perform a software update on apparatuses capable of reproducing the data from the information recording medium 100.

The information for software updating 110 may be stored in an area of the information recording medium 100 that is normally accessible to the user. Additionally, aspects of the present invention allow the information for software updating 110 to be stored in an area of the information recording medium 100 the apparatus can access but that the user cannot normally access through normal operation. By storing the information for software updating 110 in an area of the information recording medium 100 that the user cannot normally access, the information for software updating 110 would not reduce the storage capacity of the information recording medium 100 from the amount that the user would normally expect (e.g., a “blank” 50 GB capacity BR-D containing a 1 GB update located in an area of the BR-D the user cannot normally access would still have a capacity to store 50 GB of data for the user). Additionally, by storing the information for software updating 110 in an area the user cannot normally access, the update can occur without requiring the involvement (or perhaps even the knowledge) of the user. Further still, proprietary or confidential data in files required for an update, but that the manufacturer does not wish the user to access, can be stored more safely in such an area.

The information for software updating 110 may be of several forms. According to one example embodiment of the present invention, information for software updating 110 can include information for software updating and the files required to perform the software update, so that the software in the reading apparatus can be updated directly by using the update files. Thus, when a user desires to reproduce data from an information recording medium 100, when a need to update the apparatus is determined, the update is performed prior to the data reproduction, thereby conveniently performing software updating and allowing the user to reproduce the data with the necessary update. Still further, aspects of the present invention provide that the software update can occur automatically without the user's involvement.

Alternatively, another aspect of the present invention provides that the information for software updating 110 can include only information for the user about a software updating and not all the files and data required for the update. In this situation, if a software update is needed, the user is informed of the required update, such as by an update message informing that an update is needed. The update message may contain an inquiry as to whether the user wants to directly access a network (not shown), via a networked apparatus, to download and perform the software updating, to allow the user to directly access the network (not shown) and perform the software update when he or she decides to directly perform software updating. Another alternative example embodiment of the present invention is that the information for software updating 110 may inform the user to contact a vendor for an upgrade kit, call a telephone number for instructions, or perform an action to complete an upgrade that requires activity by the user.

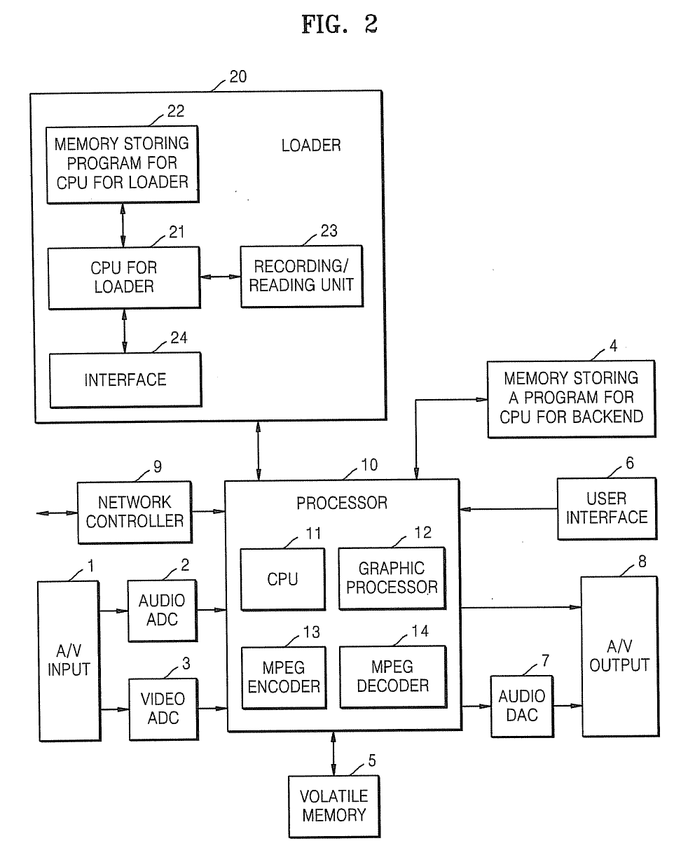

FIG. 2 is a schematic block diagram of an A/V data recording/reproducing apparatus according to an example embodiment of the present invention. Referring to FIG. 2, the apparatus, which records data on and reproduces data from an information recording medium (such as an information recording medium 100 shown in FIG. 1), includes an AV input unit 1 that receives an A/V signal; an audio analog-to-digital converter (ADC) 2 that converts an analog audio signal into a digital audio signal; a video ADC 3 that converts an analog video signal into a digital video signal; a memory 4 that stores a central processing unit (CPU) program for a backend; a volatile memory 5; a user interface 6, such as a remote control or keypad, via which a user input is received; an audio digital-to-analog converter (DAC) 7 that converts a digital audio signal into an analog audio signal; an A/V output unit 8 that outputs an A/V signal; a network controller 9 that controls a network access; a processor 10 that decodes MPEG data, performs graphic processing, and controls the overall operation of the apparatus; and a loader 20 that loads an information recording medium 100 (not shown) into the apparatus.

The memory 4 stores a program to be run by a CPU. The memory 4 may be a flash memory in which a read/write operation can be performed to change the stored program and thus allow a CPU program to be updated.

The loader 20 includes a CPU 21, which controls the overall operation of the loader 20; a memory 22, which stores a program for the CPU 21; a recording/reading unit 23, which reads data from and records data to the loaded information recording medium 100; and an interface 24, which provides an interface with a backend (not shown). Although not shown, the recording/reading unit 23 may include additional components, such as a pickup, a servo, a radio-frequency amplifier (RF-AMP), and a digital signal processor (DSP).

The processor 10 includes a CPU 11, which controls elements of the processor 10 and the overall system. The processor 10 may contain a graphic processor 12 to perform graphic processing for a graphic user interface, an MPEG encoder 13, and an MPEG decoder 14.

The CPU 11 reads program data from the memory 4, moves the read program data to the volatile memory 5, and then executes a related program, when the apparatus is booted, powered-on, or reset.

In particular, when an information recording medium 100 in which both AV data and information for software updating 110 are stored, is loaded into the apparatus (such as by inserting a HD-DVD), the CPU 11 according to an example embodiment of the present invention reads the information for software updating 110 from the information recording medium 100, determines whether software updating is needed, and performs an update by using the information for software updating 110 update files stored in the information recording medium 100 or outputs an update message containing information about the update when software updating is needed, prior to reproduction of the AN data. If the update message is output, if a user wants to update current software according to the update message, the user may access a website that provides update files, download desired update files, and perform updating, via the network controller 9. Also, the CPU 11 may control the A/V data to be reproduced when the user desires to reproduce it by using the current software without updating the current software. Additionally, the CPU 11 simply reproduces the A/V data from the information recording medium 100 when an update is not needed.

Software to be updated can include programs such as a CPU program for a backend, which is stored in the memory 4, or a CPU program for a loader 20, which is stored in the memory 22. Although it is not common, software to be updated may additionally be a program that the MPEG encoder 13 or the MPEG decoder 14 uses.

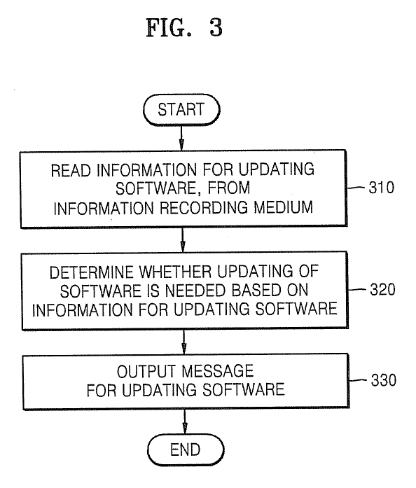

FIG. 3 is a flowchart illustrating a method of reproducing data to inform a user of a necessary update according to an example embodiment of the present invention. Referring to FIGS. 1 and 3, information for software updating 110 in an apparatus which reproduces data is read from the information recording medium 100 at block 310. The software may be a program executed by a CPU for a backend, a program executed by a CPU for a loader 20, a program executed by a CPU 11 for a processor 10, an MPEG encoder 13, an MPEG decoder 14, or similar software of the apparatus.

It is determined whether a software update is needed based on the read information for software updating 110, at block 320, when the information recording medium 100 is loaded in the apparatus. When the version of software in the information for software updating 110 is of a later release or higher revision than that of software installed in the apparatus, it is determined that a software update is needed.

If it is determined that a software update is needed, a message informing the user of the software update is output at block 330. If the message for software updating is included in the information for updating software 110 in the information recording medium 100, the message in the information for updating software 110 is used. Otherwise, a default update message set in the apparatus is used.

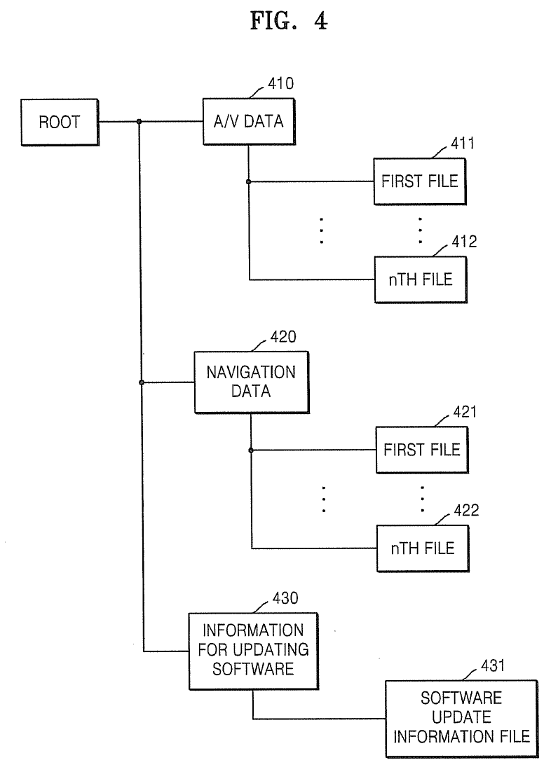

FIG. 4 is a block diagram of a file system of data stored in an information recording medium 100 according to an example embodiment of the present invention. Referring to FIGS. 1 and 4, the information recording medium 100 may store A/V data 410, navigation data 420 for controlling reproduction of the A/V data 410, and information for updating software 430 of a reproducing apparatus.

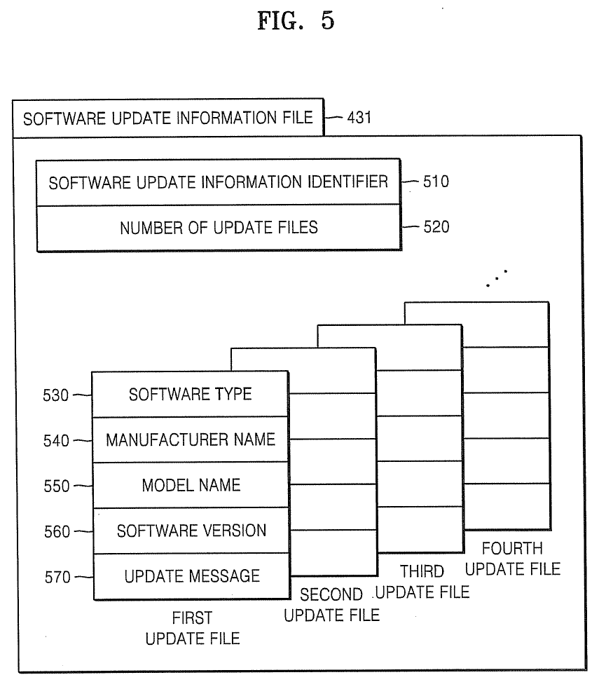

The information for software updating 430 contains a software update information file 431 that provides information regarding the software update. The content of an example software update information file 431 is shown in FIG. 5. Referring to FIG. 5, the software update information file 431 contains a software update information identifier 510, which identifies the software update information file 431 as a file that contains software update information, information regarding the number of update files 520, and plural pieces of update file information.

Each piece of the update file information may contain software type information 530, manufacturer name information 540, model name information 550, software version information 560, and an update message 570. The software type information 530 indicates which CPU can execute software of a corresponding update file. That is, the software type information 530 indicates whether the corresponding update file is software to be executed by a CPU for a loader 20, a CPU for a backend, or other blocks of a processor.

The update message 570 may contain information that provides users with detailed information about the software update. Alternatively, the update message 570 stored in an information recording medium 100 may contain only basic information for displaying a message such as a revision number or release date and use the default update message 570 stored on a reproducing apparatus. Thus, a reproducing apparatus may combine the basic information with other information and displays the result of the combination as the message to the user.

The following content may be included into the update message 570, as shown in FIG. 8.

1) The release date of an update file: The update message 570 shown in FIG. 8 may contain a sentence, for example, “This title requires software update released Jun. 3, 2006” regarding the release date of an update file.

2) Problems that may occur unless updating is performed: The update message 570 shown in FIG. 8 may contain a sentence, for example, “Black dots may appear during playback unless a software update is performed” regarding a problem that may occur if the update is not performed.

3) An updating method, e.g., the name of a website from which update files can be downloaded, and (on networked apparatuses) an inquiry as to whether a user desires to access the website to immediately perform the update: The update message 570 shown in FIG. 8 may contain a sentence, for example, “Download the desired update files by accessing website at www.xxxx?” and selections of “Yes” or “No”.

4) An inquiry as to whether the user wishes to continue without performing the update: The update message 570 shown in FIG. 8 may contain the sentence, for example, “Continue without updating software?” and provide the user with selections of “Yes” or “No”.

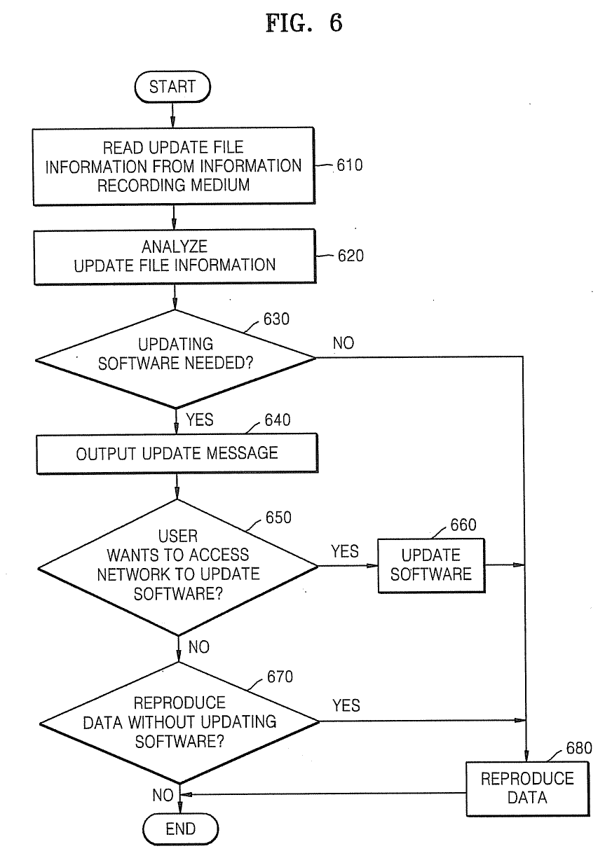

FIG. 6 is a flowchart illustrating a method of reading data according to another example embodiment of the present invention. Referring to FIGS. 1 and 6, when a user loads an information recording medium 100 according to an example embodiment of the present invention into a reproducing apparatus in order to reproduce data from the information recording medium 100, a CPU of the reproducing apparatus reads update file information from the information recording medium 100 before reproduction of the stored data at block 610.

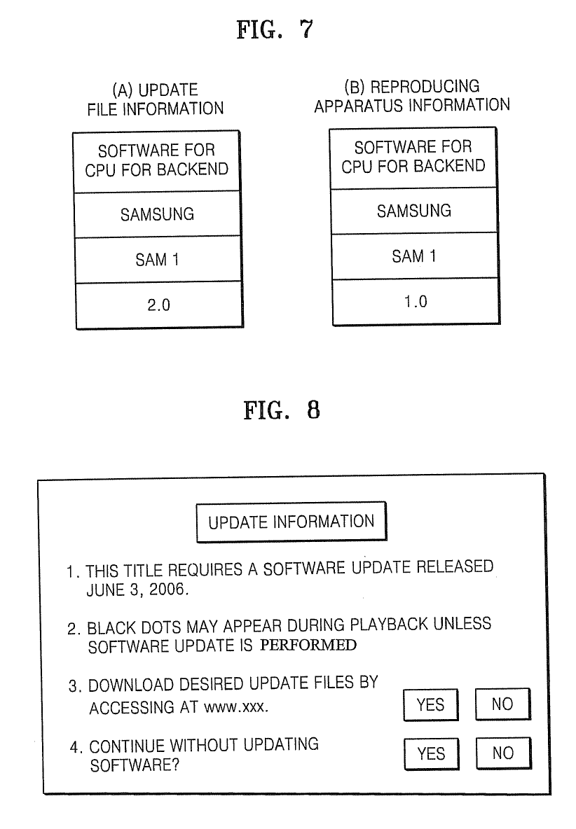

Then, the CPU analyzes the read update file information at block 620. That is, the CPU searches the read update file information for update file information that matches the specifications of the reproducing apparatus. For example, referring to FIG. 7, when software type is “software for a CPU for backend”, the manufacturing company's name is “Samsung”, and the model name is “SAM 1”, an apparatus matching those specifications would search the update file information for the above particulars.

Next, the CPU determines whether an update is needed at block 630. That is, the CPU compares the version and release date of the software that the reproducing apparatus is currently using, with version and release date information specified in the update file information and determines that an update is needed when the version reported in the information for software updating 110 was released later or is of a higher number version than the version of the software installed in the reproducing apparatus. Otherwise, the apparatus determines that an update is not needed. For example, as shown in FIG. 7, when the information for software updating 110 has a software version specified in update file information of 2.0 and the version of software in a reproducing apparatus is 1.0, the apparatus determines that a software update is needed. If a software update is not needed, the CPU controls the reproducing apparatus to reproduce the data from the information recording medium at block 680.

If software update is needed, the apparatus outputs an update message at block 640. If an update message is included in the information for updating software 110 in the information recording medium 100, the update message is output. Otherwise, if a message is to be output but no specific message is included on the information reproducing medium 100, a default update message set in the reproducing apparatus is output. An example of an update message is shown in FIG. 8 and discussed above.

For those apparatuses that are networked, it is determined whether a user wishes to access a network so as to perform the software update at block 650. This is the third item of the update message shown in FIG. 8 and described above. If the user wishes to update via a network, such as when the user selects “Yes” in the third item of the update message shown in FIG. 8, the software update is performed by accessing a website that provides update files, via the network controller 9, as shown in FIG. 2, at block 660, and the data is reproduced from the information recording medium 100 at block 680.

If the user does not wish to update the software, such as when the user selects “No” in the third item of the update message shown in FIG. 8, it is then determined whether the user wishes to read the data by using the existing software without updating the software at block 670.

If the user wishes to reproduce the data without updating the software, such as, when the user selects “Yes” in the fourth item of the update message shown in FIG. 8, the data is reproduced from the information recording medium 100 at block 680. If the user does not wish to reproduce the data without updating the software, such as, when the user selects “No” icon, the update message shown in FIG. 8, the apparatus is shut down, put in a default state, or the apparatus does some other action to end the method of reproducing data from the information recording medium 100.

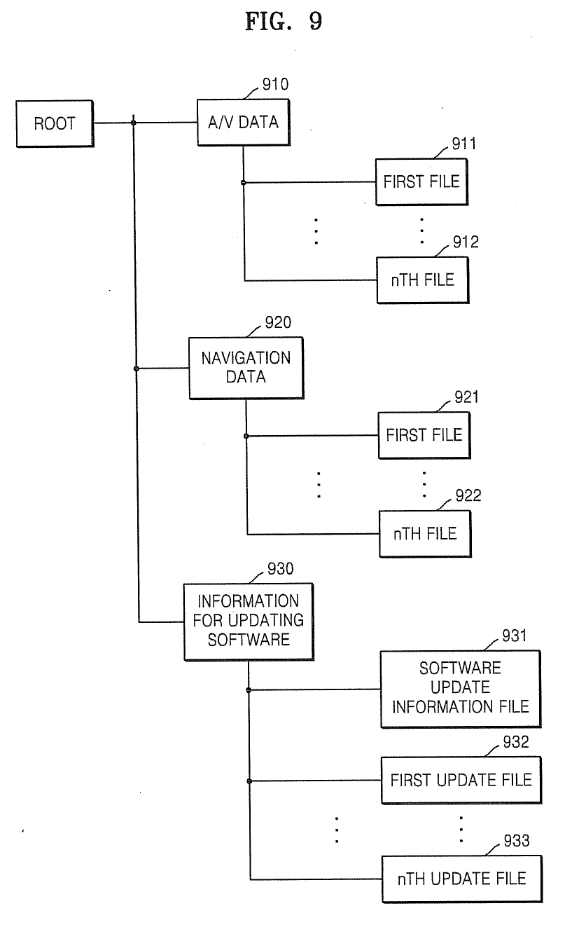

FIG. 9 is a block diagram of a file system of data stored in an information recording medium 100 (of FIG. 1) according to another example embodiment of the present invention, wherein all the files required to perform the update are included on the information recording medium. Referring to FIG. 9, the information recording medium 100 can store a variety of type of data (e.g. document files, photos, and computer programs) and, in the present exemplary embodiment, A/V data 910, navigation data 920 for controlling reproduction of the A/V data 910, and data 930 for updating software executed in a reproducing apparatus (similar to the information for software updating 110 shown in FIG. 1).

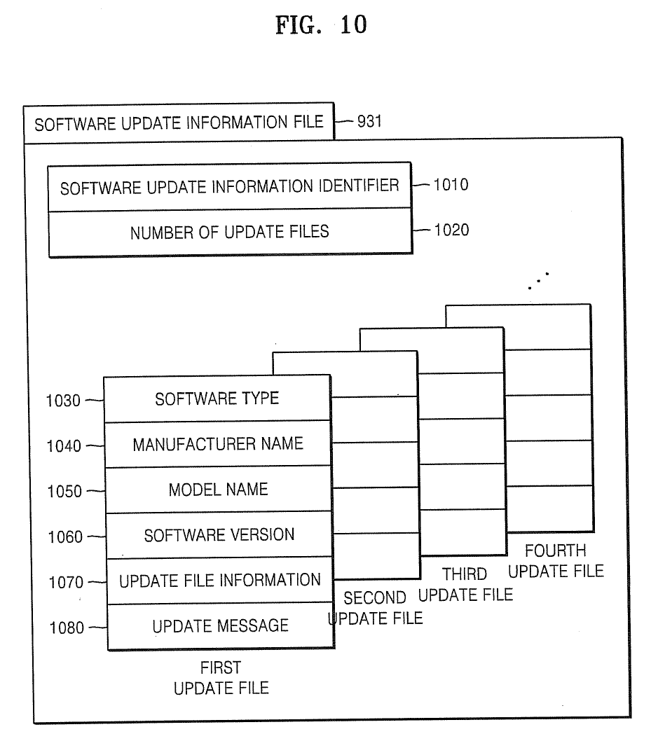

The data 930 includes a software update information file 931 that provides information regarding software updating, and may contain additional update files 932, . . . , 933. FIG. 10 illustrates the content of the software update information file 931 shown in FIG. 9 according to an example embodiment of the present invention.

Referring to FIG. 10, the software update information file 931 includes a software update information identifier 1010 that identifies the software update information file 931 as a file that provides software update information, information 1020 regarding the number of update files 1020, and plural pieces of update file information. Each piece of update file information includes software type information 1030, manufacturer name information 1040, model name information 1050, software version information 1060, update file name information 1070, and update message 1080.

The software type information 1030, the manufacture name information 1040, the model name information 1050, and the software version information 1060 are as described above with reference to FIG. 5. The update file name information 1070 provides the names of the update files 932, . . . , 933, the files that contain the data to update the apparatus. A manufacturer or vendor may wish to update the software of an apparatus without requiring the involvement of a user, or the manufacturer or vendor may wish to inform the user of the update. The update message 1080 may contain information to be displayed to the user similar to FIG. 8 and discussed above, informing of the user of the update, the update version, and if any action by the user is required to perform the update. Alternatively, the update message 1080 may contain data that instructs the apparatus to perform the update without involving or informing the user, and therefore no message would be displayed.

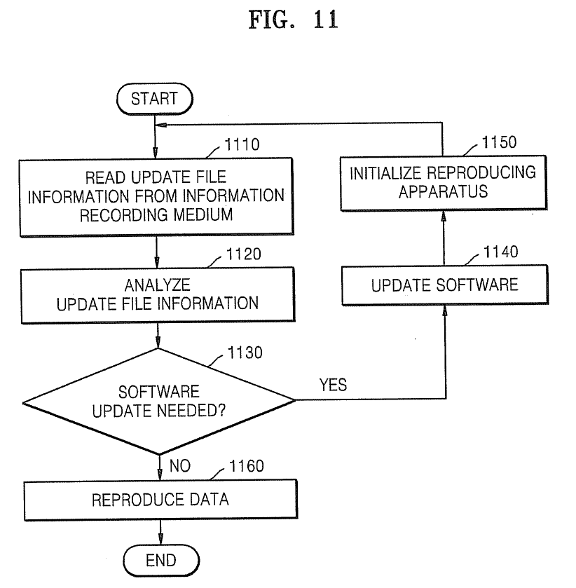

FIG. 11 is a flowchart illustrating a method of reproducing data from an information recording medium according to another example embodiment of the present invention. Referring to FIG. 11, when a user loads an information recording medium 100 into a reproducing apparatus in order to reproduce data from the information recording medium 100, a CPU of the reproducing apparatus-analyzes the type of the information recording medium 100, and reads update file information from the information recording medium 100 prior to data reproduction at block 1110.

The CPU interprets the read update file information at block 1120, and searches for update file information matches the type (manufacturer and model number) of the reproducing apparatus. The CPU determines whether a software update is needed according to the analysis at block 1130. Specifically, the CPU compares the version of software currently installed in a reproducing apparatus with the version information specified in the update file information, and determines that software update is needed when the version information specified in the update file information is later in time or higher in revision than the version of the software installed in the reproducing apparatus, and otherwise determines that a software update is not needed.

If software update is not needed, the CPU controls the reproducing apparatus to reproduce the data from the information recording medium 100 at block 1160. However, if software update is needed, the CPU performs the software update by using the update files included in the data 930 (shown in FIG. 9) for software updating, which is read from the information recording medium 100 at block 1140. For example, the CPU may, by using the update files in the data 930 for software updating, update a program for a CPU for backend, in a flash memory that stores the program for the CPU for backend; and update a program for a CPU for the loader in a flash memory that stores the program for the CPU for loader.

After performing software updating, the CPU initializes the reproducing apparatus at block 1150, and proceeds to block 1110 again. This allows for successive software updates to be performed, if required.

The above example embodiments of a method of reproducing data according to the present invention are applicable to various types of information recording medium reproducing apparatuses, including a standalone DVD player, CD player, DVD-R read/writer, and other apparatuses that can read from an information recording medium.

The above example embodiments of a method of reproducing data according to the present invention can be embodied as computer readable code in a computer readable medium. Here, the computer readable medium may be any recording medium capable of storing data that is read by a computer system, e.g., a read-only memory (ROM), a random access memory (RAM), a compact disc (CD)-ROM, a magnetic tape, a floppy disk, an optical data storage device, and so on.

As described above, according to the present invention, when a user desires to reproduce data from a specific information recording medium, it is determined whether updating of software in an reproducing apparatus is needed, and an update is performed using update files stored in the information recording medium, or a message informing the user that an update is needed is provided, if necessary. Accordingly, the user can easily receive update information and perform a software update, and a manufacturer who manufactures reading apparatuses can effectively provide the user with software updates and software update information.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, aspects of the present invention relate to updating the software on an apparatus capable of reading an information recording medium. To avoid repetition of phrases such as “updating the software or firmware of the reading device or the reading and writing device or the system containing the reading device or the system containing a reading and writing device” it will be understood by those skilled in the art that aspects of the present invention relate to devices that can read data from an information recording medium, devices that can both read from and record data on an information recording medium, and the systems that contain a device for reading or a device for reading from and writing data to an information recording medium. It will additionally be understood by those skilled in the art that aspects of the present invention relate to updating, modifying, replacing, or deleting the software, instructions, configuration data, and similar information stored in the firmware, memory, flash memory, or other storage unit that is used by the devices or systems to manage or control the operation or functions of the devices or systems. Accordingly, it is intended, therefore, that the present invention not be limited to the various example embodiments disclosed, but that the present invention includes all embodiments falling within the scope of the appended claims.

What is claimed is:

1. An information recording medium for use in an apparatus which reproduces data, comprising:
data; and
information for updating software stored in the apparatus which reproduces the data.

2. The information recording medium of claim 1, wherein the information for software updating is stored in a location of the information recording medium not accessible to the user through normal operation of the apparatus.

3. The information recording medium of claim 1, wherein the information for updating software comprises:
a software update information file containing information regarding updated software, and the software update information file comprises at least one of:
software type information indicating which central processing unit (CPU) is capable of executing the updated software;
a name of a manufacturer of the apparatus the updated software is for;
a model name of the apparatus the updated software is for;
information regarding the version of the updated software; and
an update message to inform a user of the updated software and information about the update.

4. The information recording medium of claim 3, wherein the update message comprises at least one of:
a release date of the updated software file;
a problem which is likely to occur unless the software is updated;
a method of updating the software;
a query of the user as to whether the user desires to access a current network in order to update the software; and
a query of the user as to whether the user desires to reproduce the data by using the installed software in the apparatus without updating the software.

5. The information recording medium of claim 1, wherein the information for software updating comprises:
a software update information file containing information regarding the update software file, the software information file comprising at least one of:
software type information indicating which CPU is capable of executing the software update;
a name of a manufacturer of the apparatus the software update is for;
a model name of the apparatus the software update is for;
information regarding the version of the software update;
a name of the update software file; and
an update message to inform a user of the updated software and information about the update; and
the update software file.

6. The information recording medium of claim 5, wherein the update message further comprises at least one of:
a release date of the updated software file;
a problem which is likely to occur unless the software is updated; and
a method of updating the software.

7. An information recording medium for use in an apparatus which records data on the information recording medium, comprising:
a data area to record data; and
a designated area to record information for updating software stored in the apparatus which records the data in the data area of the information recording medium.

8. The information recording medium of claim 7, wherein the designated area on the information recording medium is not accessible to the user through normal operation of the apparatus.

9. The information recording medium of claim 7, wherein the information for updating software comprises:
a software update information file containing information regarding updated software, the software update information file comprising at least one of:
software type information indicating which central processing unit (CPU) is capable of executing the updated software;
a name of a manufacturer of the apparatus the updated software is for;
a model name of the apparatus the updated software is for;
information regarding the version of the updated software; and
an update message to inform a user of the updated software and information about the update.

10. The information recording medium of claim 9, wherein the update message further comprises at least one of:
a release date of the updated software file;
a problem which is likely to occur unless the software is updated;
a method of updating the software;
a query of the user as to whether the user desires to access a current network in order to update the software; and
a query of the user as to whether the user desires to record the data by using the installed software in the apparatus without updating the software.

11. The information recording medium of claim 7, wherein the information for software updating comprises:
a software update information file containing information regarding the update software file, the software information file comprising at least one of:
software type information indicating which CPU is capable of executing the software update;
a name of a manufacturer of the apparatus the software update is for;
a model name of the apparatus the software update is for;
information regarding the version of the software update;
a name of the update software file; and
an update message to inform a user of the updated software and information about the update; and
the update software file.

12. The information recording medium of claim 11, wherein the update message further comprises at least one of:
a release date of the updated software file;
a problem which is likely to occur unless the software is updated; and
a method of updating the software.

13. A method of reproducing data from an information recording medium, the method comprising:
reading information for updating software in an apparatus which reproduces data, from the information recording medium;
determining whether updating of the software is necessary, based on the information for software updating; and
outputting an update message to the user when updating of the software is necessary.

14. The method of claim 13, wherein the software comprises at least one of:
software for execution by a central processing unit (CPU) of the apparatus;
software for execution by an encoder or a decoder of the apparatus; and
software for execution by a central processing unit of a loading device which loads the information recording medium into the apparatus.

15. The method of claim 14, wherein the information for software updating comprises at least one of;
software type information indicating which CPU is capable of executing the updated software;
a name of a manufacturer of the apparatus the updated software is for;
a model name of the apparatus the updated software is for;
information regarding the version of the updated software; and
an update message to inform a user of the updated software and information about the update.

16. The method of claim 15, wherein the determining of whether updating of the software is necessary comprises:
determining whether updating of the software is necessary by using the information regarding the version of the updated software.

17. The method of claim 16, wherein the update message comprises at least one of:
a release date of the updated software file;
a method of updating the software; and
a problem which is likely to occur unless the software is updated.

18. The method of claim 17, wherein the update message further comprises:
a query of the user as to whether the user desires to access a current network so as to update the software; and
the method further comprising accessing the network and updating the software, when the user desires to access the current network to update the software.

19. The method of claim 18, wherein the update message further comprises:
a query of the user as to whether the data is to be reproduced without updating the software; and
the method further comprising reproducing the data, when an instruction to reproduce the data without updating the software is received from the user.

20. The method of claim 19, wherein the outputting of the update message comprises providing, via a user interface, one of:
the update message contained in the information for software updating, which is read from the information recording medium; and
a default update message set in the apparatus.

21. The method of claim 20, further comprising:
reproducing the data from the information recording medium when updating the software is not necessary.

22. An apparatus for reproducing data from an information recording medium, the apparatus comprising:
a central processing unit (CPU) arranged to control the apparatus to reproduce the data from the information recording medium; and
a memory to store software to be executed by the CPU,
wherein the CPU reads information for updating software in the apparatus from the information recording medium and determines whether updating of the software is necessary based on the information for software updating, and controls an update message to be output when updating of the software is necessary.

23. The apparatus of claim 22, wherein the software in the apparatus comprises at least one of:
software for execution by the CPU of the apparatus;
software for execution by an encoder or a decoder of the apparatus; and
software for execution by a CPU of a loading device which loads the information recording medium into the apparatus.

24. The apparatus of claim 23, wherein the information for software updating comprises at least one of:
software type information indicating which CPU is capable of executing the software;
a name of a manufacturer of the apparatus;
a model name of the apparatus;
information regarding the version of the software; and
an update message informing a user of update information.

25. The apparatus of claim 24, wherein the CPU determines whether updating of the software is necessary, based on the information of the version of the software.

26. The apparatus of claim 25, wherein the update message comprises at least one of:
a release date of the update software file;
a method of updating the software; and
a problem which is likely to occur unless the software is updated.

27. The apparatus of claim 26, wherein the update message further comprises:
a query of the user as to whether a user desires to access a current network and update the software; and
accessing the network and updating the software when an instruction from the user to access the network so as to update the software is received.

28. The apparatus of claim 27, wherein the update message further comprises:
a query of the user as to whether the user desires to reproduce the audio/video data by using the software without updating the software; and
the CPU reproduces the data, when an instruction to reproduce the data by using the software without updating the software is received from the user.

29. The apparatus of claim 28, wherein the CPU provides, via a user interface, one of:
the update message contained in the information for software updating, which is read from the information recording medium; and
a default update message set in the apparatus.

30. The apparatus of claim 29, wherein the CPU reproduces the data from the information recording medium when updating of the software is not necessary.

31. A method of reproducing data from an information recording medium, the method comprising:
reading information for updating software in an apparatus which reproduces the data from the information recording medium;
determining whether updating of the software is necessary, based on the information for software updating;
updating the software by using an update file contained in the information for software updating, when updating of the software is needed; and
reproducing the data from the information recording medium.

32. The method of claim 31, wherein the software comprises at least one of:
software for execution by the CPU of the apparatus;
software for execution by an encoder or a decoder of the apparatus; and
software for execution by a CPU of a loading device which loads the information recording medium into the apparatus.

33. The method of claim 32, wherein the information for software updating comprises at least one of:
software type information indicating which CPU is capable of executing the software;
a name of a manufacturer of the apparatus;
a model name of the apparatus;
information regarding the version of the software; and
a name of an update file.

34. The method of claim 33, wherein the determining of whether updating of the software is necessary comprises:
determining whether updating of the software is necessary based on the information regarding the version of the software.

35. An apparatus for reproducing data from an information recording medium, the apparatus comprising:
a central processing unit (CPU) arranged to control the apparatus to reproduce the data from the information recording medium; and
a memory to store software to be executed by the CPU;
wherein the CPU reads information for updating software in the apparatus from the information recording medium, determines whether updating of the software is necessary based on the information for software updating, updates the software by using an update file contained in the information for software updating, and controls the data to be reproduced.

36. The apparatus of claim 35, wherein the software comprises at least one of:
software for execution by the CPU of the apparatus;
software for execution by an encoder or a decoder of the apparatus; and
software for execution by a CPU of a loading device which loads the information recording medium into the apparatus.

37. The apparatus of claim 36, wherein the information for software updating comprises at least one of:
software type information indicating which CPU is capable of executing the software;
a name of a manufacturer of the apparatus the updated software is for;
a model name of the apparatus the updated software is for;
information regarding the version of the updated software; and
a name of an update file.

38. The apparatus of claim 37, wherein the CPU determines whether updating of the software is necessary based on the information regarding the version of the software.
